(19) United States
(12) Patent Application Publication
(10) Pub. No.: US 2008/0173093 A1
(43) Pub. Date: Jul. 24, 2008

(54) SYSTEM AND METHOD FOR PHOTOACOUSTIC TOMOGRAPHY OF JOINTS

(75) Inventors: Xueding Wang, Canton, MI (US); David Chamberland, Medford, OR (US); Paul Carson, Ann Arbor, MI (US); Brian Fowlkes, Ann Arbor, MI (US); Ron Bude, Plymouth, MI (US); Blake Roessler, Ann Arbor, MI (US); Jonathan Rubin, Ann Arbor, MI (US); Nicholas A. Kotov, Ypsilanti, MI (US)

Correspondence Address: BROOKS KUSHMAN P.C., 1000 TOWN CENTER, TWENTY-SECOND FLOOR, SOUTHFIELD, MI, 48075, US

(73) Assignee: THE REGENTS OF THE UNIVERSITY OF MICHIGAN, Ann Arbor, MI (US)

(21) Appl. No.: 12/016,505

(22) Filed: Jan. 18, 2008

Related U.S. Application Data
(60) Provisional application No. 60/881,123, filed on Jan. 18, 2007.

(51) Int. Cl. G01N 29/00

(52) U.S. Cl. 73/602

(57) ABSTRACT

A system and method for photoacoustic tomography of a sample, such as a mammalian joint, includes a light source configured to deliver light to the sample, an ultrasonic transducer disposed adjacent to the sample for receiving photoacoustic signals generated due to optical absorption of the light by the sample, a motor operably connected to at least one of the sample and the ultrasonic transducer for varying a position of the sample and the ultrasonic transducer with respect to one another along a scanning path, and a control system in communication with the light source, the ultrasonic transducer, and the motor for reconstructing photoacoustic images of the sample from the received photoacoustic signals.

### CROSS-REFERENCE TO RELATED APPLICATIONS

This application claims the benefit of U.S. provisional application Ser. No. 60/881,123 filed Jan. 18, 2007, which is incorporated by reference herein.

### BACKGROUND OF THE INVENTION

1. Field of the Invention

This invention relates to a system and method for photoacoustic tomography of samples, such as mammalian joints.

2. Background Art

Photoacoustic tomography (PAT) may be employed for imaging tissue structures and functional changes, and describing the optical energy deposition in biological tissues with both high spatial resolution and high sensitivity. PAT employs pulsed electromagnetic signals to generate ultrasonic waves. In PAT, a short-pulsed electromagnetic source—such as a tunable pulsed laser source, pulsed radio frequency (RF) source, or pulsed lamp—is used to irradiate a biological sample. The photoacoustic (ultrasonic) waves excited by thermoelastic expansion are then measured around the sample by high sensitive detection devices, such as ultrasonic transducer(s) made from piezoelectric materials and optical transducer(s) based on interferometry. Photoacoustic images are reconstructed from detected photoacoustic signals generated due to the optical absorption in the sample through a reconstruction algorithm, where the intensity of photoacoustic signals is proportional to the optical energy deposition.

Optical signals, employed in PAT to generate ultrasonic waves in biological tissues, present high electromagnetic contrast between various tissues, and also enable highly sensitive detection and monitoring of tissue abnormalities. It has been shown that optical imaging is much more sensitive to detect early stage cancers than ultrasound imaging and X-ray computed tomography. The optical signals can present the molecular conformation of biological tissues and are related to significant physiologic parameters such as tissue oxygenation and hemoglobin concentration. Traditional optical imaging modalities suffer from low spatial resolution in imaging subsurface biological tissues due to the overwhelming scattering of light in tissues. In contrast, the spatial resolution of PAT is only diffraction-limited by the detected photoacoustic waves rather than by optical diffusion; consequently, the resolution of PAT is excellent (60 microns, adjustable with the bandwidth of detected photoacoustic signals). Besides the combination of high electromagnetic contrast and high ultrasonic resolution, the advantages of PAT also include good imaging depth, relatively low cost, non-invasive, and non-ionizing.

Inflammatory arthritis encompasses many pathological rheumatic diseases, including rheumatoid arthritis (RA) and seronegative spondyloarthropathies. RA, the most common form of inflammatory arthritis, is a systemic disease predominantly manifested in the synovial membrane of diarthrodial joints. About 1% of the population is affected by RA and 80% of the patients are disabled after 20 years. The synovium affected by RA is marked by neovascularization, inflammatory cell infiltration, and associated synoviocyte hyperplasia. Synovial membrane inflammation is one of the earliest pathologic changes in RA and other inflammatory joint diseases. Because the enhanced blood vessel growth contributes to the inflammatory joint destruction, inflammatory arthritis is now widely regarded as an angiogenesis-dependent disease. Despite the hypervascularization, the rheumatic synovium appears to be a hypoxic environment that is thought to be caused by an imbalance between local metabolic rate and synovial vascular supply.

Implementing effective treatments for patients with inflammatory arthritis (i.e., early initiation and optimal adjustments of therapies) requires technologies for highly sensitive early diagnosis and monitoring of disease progression. Meanwhile, there is consensus that joint imaging, instead of widely used clinical criteria, is a very significant objective method with which to measure and quantify therapeutic effects. Driven by clinical investigations looking for optimized therapies and pharmaceutical industries searching for new drugs, musculoskeletal imaging is playing an increasingly important role in the diagnosis, assessment, and monitoring of arthritis. Conventional radiography (CR) has for decades been the gold standard for detection and assessment of joint damage and continues to be the primary imaging technique for the evaluation of arthritis. This modality, however, can only demonstrate the time-integrated record of joint damage that tends to develop late in the course of the diseases and which constitutes irreversible structural injury. Furthermore, CR is fundamentally limited by its inherent inability to visualize articular soft tissues involved in the pathophysiology of arthritis.

MRI enables accurate delineation of joints as a whole organ and offers a multi-planar tomographic viewing perspective. The disadvantages of MRI include its high cost, lack of access compared to CR, lack of standardization, and poor reproducibility. Contrast agents containing gadolinium, imperative in MRI imaging studies evaluating inflammatory arthritis, have been found to cause a very morbid condition called nephrogenic systemic fibrosis in patients with renal compromise, thus limiting its availability to this patient population. Moreover, the long examination time with ensuing patient discomfort makes it difficult to use MRI repeatedly and, in some cases, impossible to use at all. Musculoskeletal ultrasound (US), another joint imaging technique that images both tissue structures and synovial blood flow, is now routinely used by a growing number of rheumatologists in the diagnosis, monitoring, and intervention of inflammatory arthritis. However, the mechanical contrast exhibited by US is not sensitive to the molecular conformation and functional changes in biological tissues (e.g., hemoglobin oxygenation). Moreover, the performance of US is highly dependent on the skills of the operator and hence is difficult to repeat and standardize for clinical trials.

Non-ionizing optical imaging of biological tissues is highly desirable because optical contrast is intrinsically sensitive to tissue abnormalities and function. Optical properties of tissue in the visible and near-infrared (NIR) region of the electromagnetic spectrum demonstrate the molecular constituents of tissues and the electronic or vibrational structures at the molecular scale. Similar to tumors, the hallmarks of rheumatic joint tissues include angiogenesis, hypervascularization, hyper-metabolism, hypoxia, and invasion into normal adjacent tissues. Optical properties may be used to quantify these morphological and functional changes and, consequently, can potentially enable the early diagnosis of inflammatory arthritis and provide improved monitoring of therapeutic interventions with a high sensitivity and specificity. Furthermore, teratogenic effects of ionizing imaging systems are avoided in optical imaging.

Optical modalities for imaging and sensing of joint diseases have drawn considerable attention. Recent studies have shown that near-infrared spectroscopy (NIRS) can be used to examine the components of synovial fluid and can potentially predict the presence or state of inflammatory arthritis. Based on NIR diffuse optical tomography (DOT), absorption and scattering imaging of joint structures of human fingers have been explored. Wavelength-dependent laser CT of human joints has been realized, which can present both structural and functional aspects of joint regions. Laser based optical tomography for imaging of finger joints has presented the advantages of optical contrast over the existing imaging modalities for early diagnosis and monitoring of inflammatory arthritis.

However, due to the overwhelming scattering of light in biological tissues, current optical technologies cannot delineate a joint as a whole organ with satisfactory imaging quality for clinical applications. Confocal microscopy can achieve ˜1 micrometer spatial resolution, but its imaging depth is limited to ˜0.5 mm in biological tissues. Optical coherence tomography (OCT) can achieve ˜10 micrometer resolution but can image only ˜1 mm deep into biological tissues. Both of these two techniques, as well as Laser Doppler imaging, are not able to provide optical information in subsurface synovial tissues in a joint when applied non-invasively. Imaging modalities based on DOT can visualize extra- and intra-articular tissue structures. However, the imaging resolution of DOT is poor and the reconstruction is ill posed (unstable) due to the diffusive nature of the imaging signals. Up to now, optical imaging of joints based on DOT cannot achieve spatial resolution better than 5 mm, which is insufficient for evaluating the small joint structures of the hands and feet.

### BRIEF DESCRIPTION OF THE DRAWINGS

FIG. 1A is a schematic diagram of a photoacoustic tomography (PAT) system for joint imaging according to the present invention;

FIG. 1B depicts scanning along a coronal section of a joint;

FIG. 1C depicts scanning along a cross-section of a joint;

FIG. 2A is a schematic diagram of a PAT system for joint imaging according to another aspect of the present invention;

FIG. 2B is an enlarged view of a photoacoustic probe used in the joint imaging system of the present invention;

FIG. 2C is an enlarged view of a circular transducer array which may be applied in the PAT system of the present invention for imaging of human finger or toe joints;

FIG. 3A is a schematic diagram of PAT of joint imaging according to the present invention based on the circular scan of an arc-shaped transducer array;

FIG. 3B is a schematic diagram of PAT of joint imaging according to the present invention based on the circular scan of a linear transducer array;

FIG. 4A is another schematic diagram of PAT of joint imaging according to the present invention based on the arcuate scan of an arc-shaped transducer array;

FIG. 4B is another schematic diagram of PAT of joint imaging according to the present invention based on the linear scan of a linear transducer array;

FIG. 5A is a 2D non-invasive photoacoustic image of a cross-section of a rat joint;

FIG. 5B is a histological picture of a cross-section of a rat joint taken along the plane as closely matched as possible to that of the PAT image;

FIG. 5C shows the image presented in FIG. 2A marked with discernable intra- and extra-articular tissue structures;

FIG. 5D is a 2D non-invasive photoacoustic image of a sagittal-section of a rat joint segmented from a 3D image along the line shown in FIG. 2A;

FIGS. 6A and 6B are 2D non-invasive PAT images of a cross-section of a normal and an inflamed rat joint, respectively;

FIGS. 7A and 7B are cross-section PAT images at proximal interphalangeal (PIP) and distal interphalangeal (DIP) joint regions, respectively, of a human finger harvested from a fresh cadaver;

FIGS. 7C and 7D are histological photographs corresponding to FIGS. 7A-7B at the PIP and DIP regions of the finger, respectively;

FIG. 8A is a 2D cross-sectional PAT image of a rat tail joint, wherein the image is based on intrinsic contrast which was taken before the administration of contrast agent;

FIGS. 8B and 8C are 2D cross-sectional PAT images of a rat tail joint which were taken after the first and second administration, respectively, of Etanercept conjugated gold nanorods; and

FIG. 8D is a histological photograph of a cross-section similar to those of FIGS. 8B-8C showing the morphological features including intra-articular tissue, vessels, and muscle.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for teaching one skilled in the art to variously employ the present invention.

The present invention includes a system and method for PAT of joints. Optical signals employed in PAT to generate ultrasonic waves are sensitive to molecular conformations of biological tissues including both deoxy- and oxy-hemoglobin, as well as to soft tissue changes such as hypervascularization. Both abnormal oxygen state and, as a consequence of increased angiogenesis, hypervascularization are known to occur in inflammatory arthritis. Based on these characteristics along with high intrinsic optical contrast of joint tissues, PAT provides a unique opportunity to enable early diagnosis and monitoring of therapeutic interventions in inflammatory arthritis with high sensitivity and specificity. The specific morphologic variables potentially monitored by PAT as bio-markers for inflammatory arthritis include increased angiogenesis and hypervascularization in proliferative joint-associated tissues, and morphological changes and swelling of joints.

Besides these structural changes, PAT employing multiple wavelengths may evaluate hemodynamic changes in joint tissues such as hemoglobin concentration (and, by extrapolation, blood volume) and blood oxygen saturation, which can potentially quantify the hyperemia and hypoxia in extra- and intra-articular joint tissues. The high sensitivity of optical signals to these structural and functional hallmarks of synovitis makes PAT a potentially powerful imaging technology with which to study inflammatory joint diseases. Besides PAT based on intrinsic optical contrast, PAT of contrast agents (e.g. absorbing dyes and nanoparticles) conjugated with bio-markers may be employed to realize molecular imaging of changes in inflamed joints, such as cellular signal pathways and cytokines.

It has been shown experimentally that the spatial resolution of PAT is primarily limited by the bandwidth of detected photoacoustic waves. As a result, the resolution of PAT is excellent. The high spatial resolution of PAT especially favors imaging of the small joint structures of the hands and feet that are usually among the earliest to be affected by rheumatoid arthritis and are widely accepted to be markers of overall joint damage. PAT does not depend on ballistic/quasi-ballistic or backscattered light as OCT does. Any light, including both singly and multiply scattered photons, contributes to the imaging signal. As a result, the imaging depth of PAT is sufficient (>5 cm in the NIR region) to cover a finger joint as a whole organ. Because photoacoustic waves travel only one way to reach the ultrasonic transducer rather than two ways as in the conventional ultrasonography or OCT, PAT does not show strong speckle artifacts. Furthermore, the system and method of the present invention are compatible with existing ultrasonography systems and can potentially enable multi-modality imaging of joints by presenting both optical and ultrasonic contrasts.

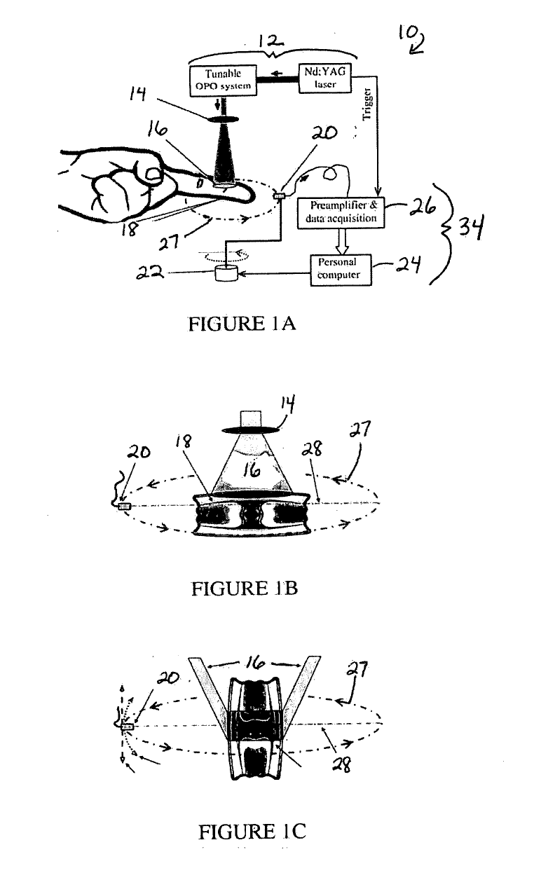

A PAT system for joint imaging according to the present invention is shown in FIG. 1A and is designated generally by reference numeral 10. System 10 may include laser pulse generation and delivery and wavelength tuning, photoacoustic signal generation and reception, and reconstruction and display of the structural and functional photoacoustic images. According to one aspect of the present invention, at least one light source or laser 12, such as an optical parametric oscillator (OPO) laser system (e.g., Vibrant B, Opotek) pumped by an Nd:YAG laser (e.g., Brilliant B, Bigsky; e.g., working at 532 nm—second-harmonic), may be used to provide laser pulses (e.g., ˜5 ns) with a tunable wavelength in the NIR region (e.g., between 680 nm and 950 nm). Other spectrum regions can also be realized by choosing other tunable laser systems (e.g., Ti:Sapphire laser, dye laser, or OPO pumped by 355 nm Nd:YAG laser) or lamps. The light source 12 for PAT according to the present invention may be any device that can provide short light pulses with high energy, short linewidth, and tunable wavelength, and other configurations are also fully contemplated. The selection of a laser system and laser spectrum region depends on the imaging purpose, specifically the biochemical substances to be visualized and the types of functional parameters to be studied. The studied spectral region may range from ultraviolet to infrared (300 nm to 1850 nm), but is not limited to any specific range.

System 10 may include a lens 14 for expanding and/or homogenizing the light generated by laser 12, whereafter the laser beam 16 may irradiate an imaged sample 18 (e.g., mammalian joint) with an input energy density such as ˜10 mJ/cm² that is much lower than the ANSI safety limit. Pulsed light from the light source 12 may induce photoacoustic signals in an imaged sample 18 that may be detected by a transducer 20, such as a high-sensitivity, wide-bandwidth ultrasonic transducer, to generate 2D or 3D photoacoustic tomographic images of the sample 18. The spatially distributed optical energy in the sample 18 generates proportionate photoacoustic waves due to the optical absorption of biological tissues (i.e., optical energy deposition). Transducer 20 may be positioned along a scanning path 27 using a stepper motor 22 or the like operably connected to the transducer 20 and controlled by a computer 24. Alternatively, motor 22 could be operably connected to the sample 18 for positioning the sample 18 with respect to a stationary transducer 20, or one or more motors 22 could be utilized to vary the position of both the sample 18 and the transducer 20.

The light energy can be delivered to the sample 18 through any methods, such as free space beam path or optical fiber(s). To couple the photoacoustic waves, both the sample 18 and the transducer 20 may be immersed in a tank of warm water. It is understood that the signal between the sample 18 and the transducer 20 may be coupled with any suitable ultrasound coupling material such as, but not limited to, water, mineral oil and ultrasound coupling gel. A focused ultrasound transducer (or a transducer array) may be employed for signal receiving and images generated directly as in traditional ultrasonography, or photoacoustic signals may also be received with non-focused transducer(s) and images reconstructed through a reconstruction algorithm. Other high sensitive ultrasound detection devices, such as an optical transducer based on interferometry, can be used instead of transducer 20. A pre-amplifier and data acquisition system 26 may be provided in communication with laser 12 and transducer 20 and, together with computer 24, comprise a control system 34. Control system 34 is operable to reconstruct photoacoustic images of the sample 18 from the received photoacoustic signals, and may include an optional amplifier (e.g., PR5072, Panametrics) and oscilloscope (e.g., TDS 540B, Tektronics).

Designs of scanning path 27 geometries are shown in FIGS. 1B and 1C. In FIG. 1B, the light beam 16 irradiates a joint 18 from one side and the ultrasonic transducer 20 scans signals circularly around a sagittal section of the joint 18 (i.e., the plane parallel to the palm) on an imaging plane 28 that is perpendicular to the laser axis. The scanning angle will be close to 2π. This design enables the imaging of tissue structures in a plane parallel to the palm of the hand or the surface of the foot. This orientation is good for imaging the vascular supply of the fingers and toes, as the digital arteries course in this plane, along the sides of the digits. Employing this scanning path 27 geometry, structural and functional changes in vasculature induced by inflammatory arthritis may be presented by 2D photoacoustic images.

In FIG. 1C, the light beam 16 irradiates the side of a joint 18 from all the directions, which forms an irradiation band around the joint 18. This band-shaped light beam 16 may be realized through the combination of a concave lens and a concave mirror (not shown). The transducer 20 collects signals circularly around each cross section of the joint 18. One circular scan of an unfocused or a cylindrically focused transducer 20 enables a 2D mapping of the tissue structures in the cross-section lying in the imaging plane 28 (see FIG. 1A).

The design in FIG. 1C also enables 3D imaging of a joint 18 as a whole organ. In a first design (cylindrical scan), a transducer 20 may scan circularly around the finger and then may be stepped linearly along the length of the finger. This realizes a cylindrical scan around the joint 18 with a large solid angle for signal detection. In a second design (spherical scan), a transducer 20 may scan circularly around the finger and be stepped along an arc that is in a sagittal plane of the finger facing the center of the joint 18. This realizes a scan along a donut-shaped surface around the joint 18 which may lead to weaker acoustic distortion during signal acquisition (see FIG. 1C). These scanning geometries along a 2D surface around a sample 18 are able to describe 3D distributed tissue structures and functional parameters in the sample with satisfactory spatial resolution.

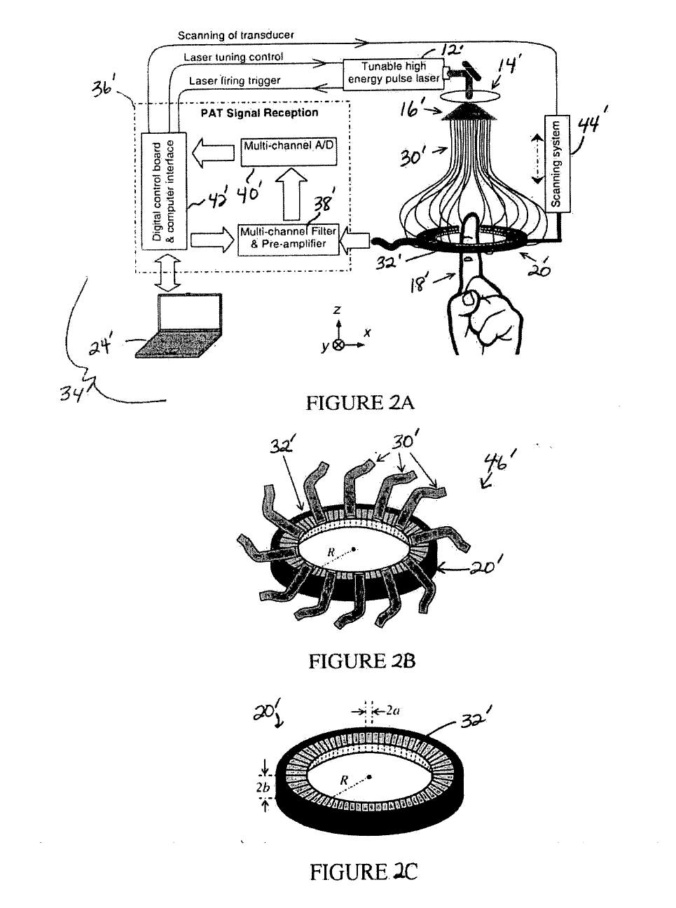

Turning now to FIG. 2A, another design of a PAT system for joint imaging is depicted and designated generally with reference numeral 10′, wherein like components from FIG. 1A retain the same reference numeral except for the addition of a prime (′) designation. It is understood that the description of components above relating to FIG. 1A may be equally applicable to the system of FIG. 2A and vice versa.

With reference to FIG. 2A, after being expanded, the light beam 16′ may be coupled into the input end of a bundle of optical fibers 30′ (or light guide) and delivered to the imaged joint 18′ with an input energy density less than the ANSI safety limits. The light-generated photoacoustic signals in articular tissues may be measured by a transducer 20′, such as having an annular-shaped array 32′ depicted herein. Between the finger 18′ and the transducer 20′, an ultrasound coupling material such as water, oil, ultrasound coupling gel, or the like can be applied. The received photoacoustic signals may be sent to a PAT control system 34′ which includes computer 24′ or other suitable processor/controller and PAT signal reception circuitry 36′. This signal reception circuitry 36′ may include a filter and pre-amplifier 38′ (e.g., multi-channel pre-amplifier with, for example, 64, 128, or 256 channels), A/D converter 40′ (e.g., multi-channel A/D converter with, for example, 64, 128, or 256 channels), and digital control board and computer interface 42′ in communication with the computer 24′, the amplifier 38′, and the A/D converter 40′. As such, the photoacoustic signals detected by the transducer 20′ may be amplified, digitized, and then sent to the computer 24′. The control system 34′ may also receive the triggers from laser 12′, may control the tuning of the wavelength of the laser 12′, and may control the scanning of the transducer 20′ via a scanning system 44′. After the signals are collected by the computer 24′, photoacoustic images can be generated through a reconstruction algorithm. It is understood that the control system 34′ depicted in FIG. 2A is only an example, and that other systems with similar functions may also be employed in the system 10, 10′ according to the present invention for control and signal receiving.

PAT of joints according to the present invention may use any ultrasound detection device, e.g. single element transducers, 1D or 2D transducer arrays, optical transducers, transducers of commercial ultrasound machines, and others. The photoacoustic signals can be scanned along any surfaces around the sample 18, 18′. Moreover, detection at the detection points may occur at any suitable time relative to each other. Transducer 20, 20′ may employ a 1D array 32, 32′ that is able to achieve 2D imaging of the cross section in the sample 18, 18′ surrounded by the array 32, 32′ with a single laser pulse. The imaging of a 3D volume in the sample 18, 18′ may be realized by scanning the array 32, 32′ along its axis. In order to achieve 3D photoacoustic imaging at one wavelength with a single laser pulse, a 2D transducer array 32, 32′ could instead be employed for signal detection.

The parameters of ultrasonic transducer 20, 20′ include element shape, element number, array geometry, array central frequency, detection bandwidth, sensitivity, and others. The design of the transducer 20, 20′ in the system 10, 10′ according to the present invention may be determined by the imaging purpose and the sample 18, 18′, including the shape of studied sample 18, 18′, the expected spatial resolution and sensitivity, the imaging depth, and others.

The detailed geometry of a photoacoustic detection probe 46′ for use with the system 10, 10′ according to the present invention is shown in FIG. 2B. The probe 46′ may include at least one annular array of optical fibers 30′ for light delivering that is adjacent to an annular transducer array 32′ for photoacoustic signal detection. The output ends of the optical fibers 30′ may be arranged along a circle so that the light in each fiber is delivered toward the center of the circle. When a human finger is placed in this system, the light enters the finger joint in a comparatively homogeneous manner. The detailed structure of the circular transducer array 32′ is shown in FIG. 2C. According to one non-limiting aspect of the present invention, the array 32′ may have a diameter of 50 mm, an element number of 512, a central frequency of 7.5 MHZ, a −6 dB bandwidth>80%, a pitch size of 0.3 mm, and an array elevation height of 0.2 mm. The transducer 20′ can be non-focused or cylindrically focused along the elevational direction. With this PAT detection probe 46′, the expected spatial resolution in imaging the human finger or toe joint is up to 100 micrometers.

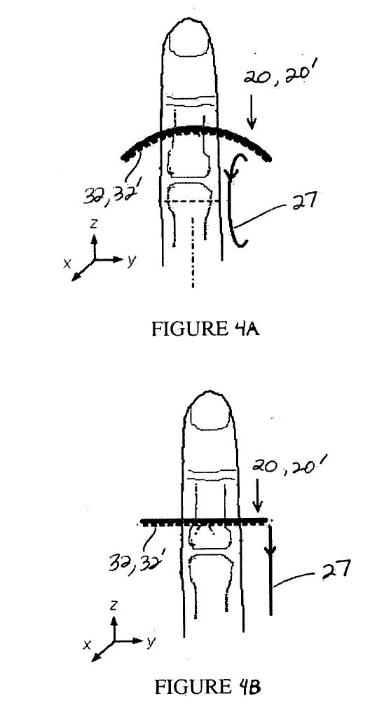

Employing the 2D circular array 32′ as shown in FIG. 2C, real-time 2D imaging of a joint can be achieved. The PAT detection probe 46′ shown in FIG. 4B can be embodied as a handheld detection device so a physician can easily manipulate the probe 46′ and look at different imaging cross-sections in the joint. The design in FIG. 2B also enables 3D imaging of a joint as a whole organ. In order to realize this, for example, the detection probe 46′ may scan vertically along the finger. The scan may be driven by the scanning system 44′ controlled by the computer 24′. With the photoacoustic signals detected along a cylindrical surface around the joint, 3D structural and functional images of the joints can be obtained.

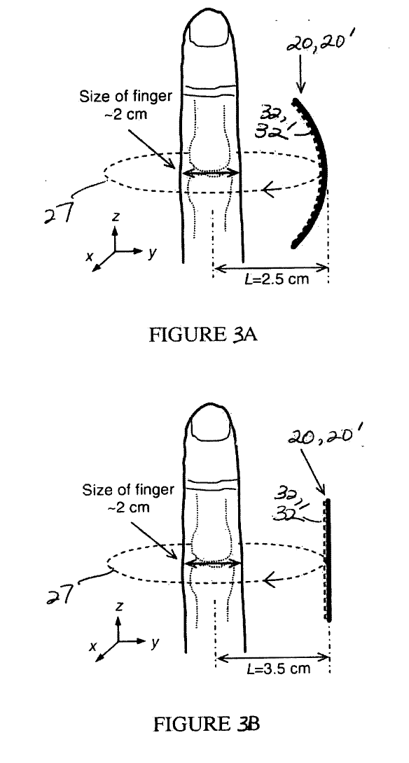

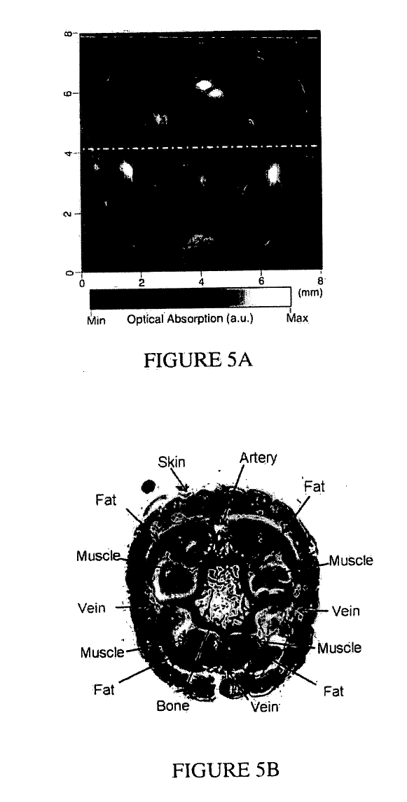

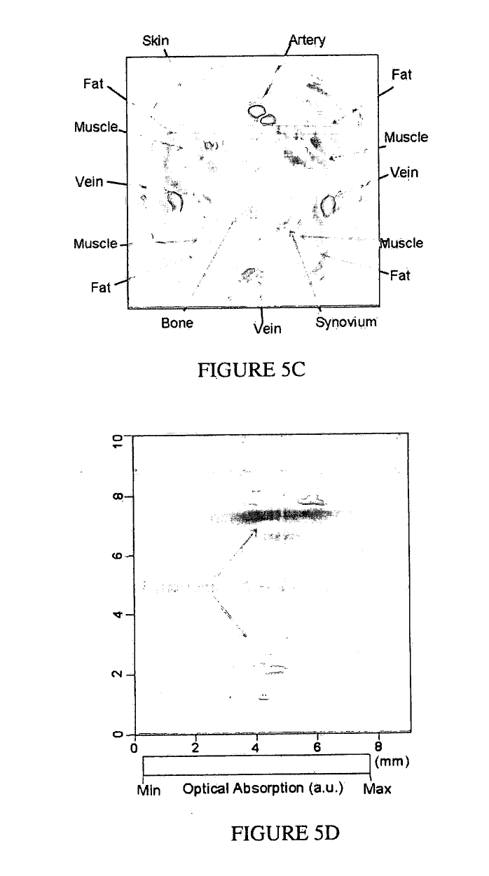

The design of the PAT detection probe 46′ shown in FIGS. 2B and 2C is only an example. PAT of joints can also be realized with other designs of light delivering and ultrasound detection. For example, the light may be delivered to the imaged joints through two circular-shaped fiber arrays, one above and the other below the ultrasound transducer array 32′. The light can also be delivered to the imaged joint through free space. Another two designs of ultrasound transducers 20, 20′ are shown in FIGS. 3A and 5B. FIG. 3A shows an arc-shaped transducer 20, 20′ that, according to one non-limiting aspect of the present invention, may have a central frequency at 7.5 MHZ, a −6 dB bandwidth>80%, an array pitch size of 0.3 mm, an element number of 128, an array elevation height of 0.3 mm, a radius of 25 mm, and an array covering angle of 90 degrees. Through a computer-controlled scanning system 44′, this arcuate array 32, 32′ can scan circularly around the imaged joint, which realizes the photoacoustic signal detection along a spherical surface around the joint. FIG. 3B shows a linear transducer array 32, 32′ that, according to one non-limiting aspect of the present invention, may have a central frequency of 7.5 MHZ, a −6 dB bandwidth of 80%, a pitch size of 0.2 mm, an array elevation height of 0.4 mm, and an element number of 128. Through a computer-controlled scanning system 44′, this linear array 32, 32′ can scan circularly around the imaged joint, which realizes the photoacoustic signal detection along a cylindrical surface around the joint.

Ultrasound arrays with still other designs may also be employed in the PAT system and method for joint imaging according to the present invention. FIG. 4A depicts an arcuate transducer 20, 20′ similar to that shown in FIG. 3A but rotated in an arcuate scan with the focal point of the transducer 20, 20′ being the center of the joint and the transducer 20, 20′ rotated about the y axis. FIG. 4B depicts a linear transducer 20, 20′ similar to that shown in FIG. 3B but scanning in a linear fashion along the z axis. Scanning as shown in FIGS. 4A and 4B can be used not only in the proximal or distal interphalangeal joints, but also in the metacarpal phalangeal joints, which are not amenable to circular scans because of their location in the hands. The scanning geometry illustrated in each of FIGS. 4A and 4B could be done independently or simultaneously on either or both the dorsal, medial, lateral or ventral surface of a hand or other joint depending on transducer access to the joint. Of course, other configurations of the transducer 20, 20′ and its array 32, 32′ are also fully contemplated, and the geometry of the transducer 20, 20′ may be optimized for various sizes of joints. For registration purposes and in order to capture as much data as possible, it may be beneficial to have two transducers 20, 20′, one on the ventral side of the joint and the other on the dorsal surface of the joint, imaging and moving in concert with each other.

Ultrasonic transducer 20, 20′ may also be used to realize conventional gray scale ultrasound imaging and Doppler ultrasound of the sample 18, 18′ by using the ultrasonic transducer 20, 20′ as both a transmitter and receiver of ultrasound signals and appropriate existing signal processing circuitry. Furthermore, ultrasound images from the same joint specimen can be used as a guide for the reconstruction of photoacoustic images.

The PAT system 10, 10′ according to the present invention can realize spectroscopic functional imaging of a joint when more than one laser wavelength is applied independently. PAT presents high sensitivity and high spatial resolution in evaluating tissue hemodynamic changes in joints, including hemoglobin oxygen saturation (SO₂) and total hemoglobin concentration (HbT). The two forms of hemoglobin, oxygenated hemoglobin (HbO₂) and deoxygenated hemoglobin (Hb), have different extinction spectra. When HbO₂ and Hb are dominant absorbing chromophores in a biological sample, the measured absorption coefficients of the sample at two wavelengths can be used to compute the concentrations of these two forms of hemoglobin. Using the system and method of the present invention, the functional parameters, SO₂ and HbT, in the sample can also be computed by solving the following two equations:

$${SO}_{2} = \frac{[ {HbO}_{2} ]}{[ {HbO}_{2} ] + [ Hb ]} = \frac{{μ}_{a}^{{λ}_{2}} {ɛ}_{Hb}^{{λ}_{1}} - {μ}_{a}^{{λ}_{1}} {ɛ}_{Hb}^{{λ}_{2}}}{{μ}_{a}^{{λ}_{1}} {ɛ}_{ΔHb}^{{λ}_{2}} - {μ}_{a}^{{λ}_{1}} {ɛ}_{ΔHb}^{{λ}_{2}}}$$

$$HbT = [ {HbO}_{2} ] + [ Hb ] = \frac{{μ}_{a}^{{λ}_{1}} {ɛ}_{ΔHb}^{{λ}_{2}} - {μ}_{a}^{{λ}_{2}} {ɛ}_{ΔHb}^{{λ}_{1}}}{{ɛ}_{Hb}^{{λ}_{1}} {ɛ}_{{HbO}_{2}}^{{λ}_{2}} - {ɛ}_{Hb}^{{λ}_{2}} {ɛ}_{{HbO}_{2}}^{{λ}_{1}}} ,$$

where μₐ is the absorption coefficient; ε_{HbO2} and ε_{Hb} are the known molar extinction coefficients of HbO₂ and Hb, respectively; ε_{ΔHb}=ε_{HbO2}−_{Hb}; and [HbO₂] and [Hb] are the concentrations of HbO₂ and Hb, respectively.

In accordance with the present invention, the sample 18 to be studied using the system 10, 10′ can be any sample, such as a living organism, animals, or humans. The system and method according to the present invention may be used on any part of the human body and adaptations may be made when different organs need to be imaged. Also, the system and method according to the present invention could be incorporated into invasive probes such as those used for endoscopy including, but not limited to, colonoscopy, esophogastroduodenoscopy, bronchoscopy, laryngoscopy, and laparoscopy. The system and method described herein can also be used for other biomedical imaging, including those conducted on animals. The performance of the system may be invasive or non-invasive, that is, while the skin and other tissues covering the organism are intact. In addition, the system and method according to the present invention may be suitable for industrial or manufacturing purposes such as, but not limited to, fluid analysis, such as in the oil or lubricant industry. The system and method according to the present invention may also be suitable for detecting defects in pipelines of any type, including those that transport oil and gas.

The computer 24, 24′ in the system 10, 10′ according to the present invention may control the light source and the signal system, control and record the photoacoustic signal data, reconstruct photoacoustic images, and generate and analyze point-by-point spectroscopic information. A “computer” may refer to any suitable device operable to execute instructions and manipulate data, for example, a personal computer, work station, network computer, personal digital assistant, one or more microprocessors within these or other devices, or any other suitable processing device.

The reception of photoacoustic signals can be realized with any proper designs of circuitry. The circuitry 36′ performs as an interface between the computer 24′ and the transducer 20′, laser 12′, and other devices. “Interface” may refer to any suitable structure of a device operable to receive signal input, send control output, perform suitable processing of the input or output or both, or any combination of the preceding, and may comprise one or more ports, conversion software, or both. A component of a reception system 36′ may comprise any suitable interface, logic, processor, memory, or any combination of the preceding.

According to the present invention, the reconstruction method used in the system 10, 10′ according to the present invention to generate photoacoustic images can be any basic or advanced algorithms, such as simple back-projection, filtered back-projection and other modified back-projection methods. The reconstruction of photoacoustic tomographic images may be performed in both spatial domain and frequency domain. Before or after reconstruction, any signal processing methods can be applied to improve the imaging quality.

PAT of joints according to the present invention can be performed based on both intrinsic and extrinsic contrasts. PAT can study the intrinsic optical properties in the joints without applying contrast agents. Furthermore, PAT can be used to image a sample in three dimensions and also enable the generation of spectroscopic curves of extrinsic substances added to any substance, including biological tissues. Added extrinsic substances include, but are not limited to, those which may enhance an image or localize within a particular region any type of therapy, including pharmaceutical applications. The possible employed contrast agent includes quantum dots, dyes, nano-particles, and absorbing proteins, and other absorbing substances.

In further accordance with the present invention, PAT of joints could be coupled with other imaging modalities such as MRI, conventional ultrasound, Doppler ultrasound, X-ray CT, infrared thermography, or a multi-modality imaging machine combining any of the above.

The performance of the PAT system for joint imaging according to the present invention has been demonstrated on rat models and human cadaveric hand joints. Rat tail joints provide good samples to study the performance of PAT of human finger joints considering their morphological similarity. Rheumatic disease rat models, including those with inflammatory arthritis, have been researched extensively and provide the opportunity to evaluate pathologic progression much more quickly than in humans. PAT, based on high sensitive optical signals, provides a potentially powerful tool for the laboratory study of inflammatory arthritis by presenting both structural and functional information of joint tissues. As PAT is non-ionizing, non-invasive, and with imaging depth in the NIR region up to several centimeters, enabling penetration of human fingers and toes, the transition from a laboratory device for animal models to clinical instrument for humans is promising.

In one study completed utilizing PAT imaging according to the present invention, Sprague Dawley rats (˜300 g, Charles River Laboratory) were utilized, wherein whole tails were harvested from the rat bodies within 1 minute after the rats were sacrificed. An electrocautery device (SurgiStat, Valleylab) was then used to clot blood and seal vessels. Before image acquisition, tail hair was removed using hair remover lotion as significant amounts can cause light scattering. The imaged joint was about 2.5 cm from the rat trunk, where the diameter of the tail was ˜8 mm and the length of a segment was ˜10 mm. After images were recorded, rat tails were saved in 10% buffered formalin for 3 days. Tails were then decalcified with formic acid for 4-7 days and monitored with a Faxitron MX-20 X-ray machine. Once specimen decalcification was completed, they were dehydrated with graded alcohol (Hypercenter XP by Shandon), embedded in paraffin (Paraplast Plus), cut into blocks, and sectioned to 7 micron thickness with a Reichert-Jung 20/30 metal knife (paraffin microtome). Hematoxylin and Eosin staining of specimen sections on glass slides was conducted. Finally, the histological pictures of specimen sections were taken with a 10× magnification.

In the 2D image of a cross section of a rat tail joint acquired through a circular scan around the cross section (see FIG. 5A), the extra- and intra-articular tissues structures have been presented successfully. The spatial resolution achieved by the imaging system and method according to the present invention is much better than the results of traditional optical imaging of joints. Based on the optical contrast among various tissues, extra- and intra-articular joint structures, including skin, fat, muscle, blood vessels, synovium and bone, are described clearly and match well with the histological picture taken from the similar cross section in the joint (see FIG. 5B). A 2D PAT image is again shown in FIG. 5C with all the discernable tissue features marked. A 3D PAT of rat tail joints based on the scan of the transducer along a spherical shape surface (spherical scan) around the joint has also been performed. The image in FIG. 5D shows a 2D sagittal plane segmented from a 3D image of the rat tail joint along the line shown in FIG. 5A. Based on the optical contrast, tissues structures in the sagittal section in the joint, especially the synovium, have been presented successfully.

In both 2D and 3D imaging of joints, PAT visualizes the optical absorption distribution in biological tissues that is contributed by various absorbing tissue constituents, including water, oxy- and deoxy-hemoglobin, and lipid. Gray scales present the optical absorption in the imaged cross-section and sagittal section of the joint, where brighter areas including blood vessels, synovial membrane and bone show relatively higher absorption compared to other surrounding tissues such as fat, which matches the results observed by traditional optical imaging of joints. At the 700-nm wavelength that was employed herein, the dominant absorbing material in soft tissues is hemoglobin. Therefore, the presented contrast among soft tissues primarily depicts the hemoglobin concentrations distributed in the joint. The bone in the joint also shows prominent photoacoustic signal intensity, which is due to not only the optical absorption but also the strong optical scattering in the bone material.

In another experiment, images of normal rat joints and those affected by inflammatory arthritis were compared. Inflammatory arthritis in rat tail joints was induced by the intra-articular administration of carrageenan (Sigma-Aldrich Co.). 0.15 mL 3% carrageenan solution in physiological saline was administrated to a group of rats (abnormal group). For comparison, injection of 0.15 mL physiological saline to the joints of another group of rats (normal group; used as control) was also performed. After 710 days, when the joints receiving carrageenan had show clinical signs (e.g. inflammation and swelling) of arthritis, both the normal and inflamed rat joints were then studied with PAT. 2D PAT of rat tail joints were performed through a circular scan around the imaged cross-section in the joints. To validate PAT results, 2D MRI imaging of normal and inflamed rat joints were also conducted with a MicroMRI system (9.4 Tesla, Inova).

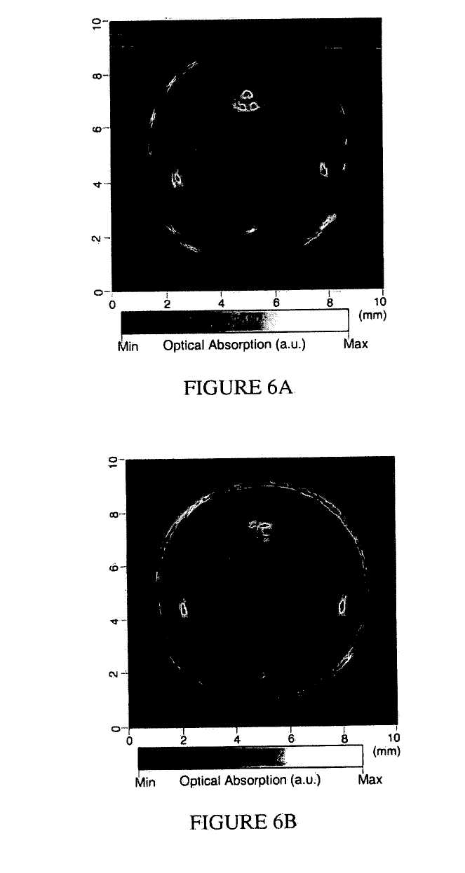

FIGS. 6A and 6B present 2D non-invasive PAT images of a cross-section of a normal rat joint and an inflamed rat joint, respectively. To prevent potential bias caused by the difference in laser light intensities for these two images, the spatially distributed optical absorption coefficients presented by these two images are normalized to the optical absorption in the areas of blood vessels. Due to the high sensitivity of optical signals to tissue inflammation, the difference between photoacoustic images of the normal (FIG. 6A) and the inflamed (FIG. 6B) joints can be clearly seen. First, it is evident that the synovium in the inflamed joint is enlarged due to the swelling of inflamed synovial tissues. Second, because inflamed tissues have higher concentrations of hemoglobin, intra- and extra-articular tissues in the inflamed joint show higher optical absorption in comparison with those in the normal joint. If multiple laser wavelengths are employed, functional photoacoustic images that show molecular biochemical changes (e.g. blood oxygenation) in joint tissues may present the differences between normal and inflamed joints more clearly.

In another study, human cadaveric finger joints were studied. The 2nd, 3rd and 4th fingers from one hand of a fresh unembalmed adult female cadaver were amputated. To maintain the tissue optical contrast, before severing the hand circumferential pressure bandages were applied to each finger to retain blood in these regions. The fingers at the levels of both the proximal interphalangeal (PIP) and distal interphalangeal (DIP) joints were imaged. The diameters of the fingers at the PIP and DIP joint regions were 20-25 mm and 15-20 mm respectively. To prevent possible contamination, the surface of the imaged fingers was covered with a thin layer of porcine gel which is both optically and acoustically transparent. After imaging, specimens were saved in 10% buffered formalin for 5 days, then decalcified with formic acid for 7-10 days and monitored with a Faxitron MX-20 X-ray machine. Once specimen decalcification was completed, the tissues were cut and trimmed for histologic evaluation. They were then dehydrated with graded alcohol, embedded in paraffin, cut into blocks, and sectioned to 10 micron thickness with Reichert-Jung 20/30 metal knife (paraffin microtome). Hematoxylin and Eosin staining of specimen sections on glass slides was conducted. Finally, histological photographs were taken with a 1× magnification.

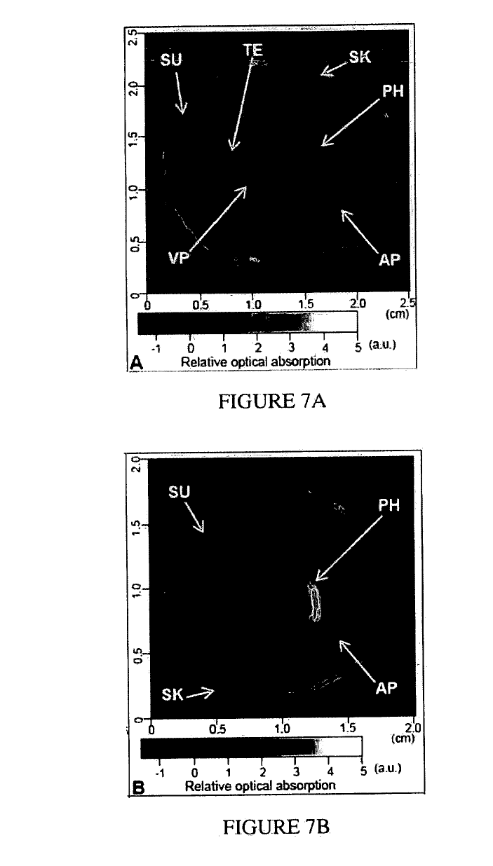

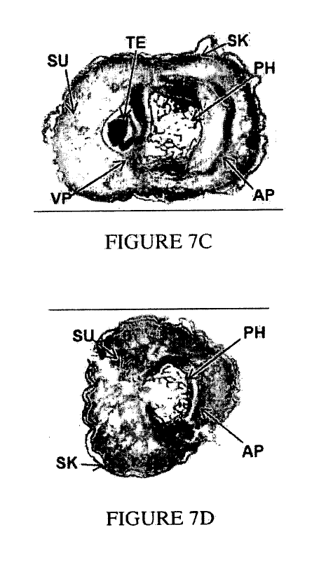

Examples of 2D PAT of axial cross sections of human fingers acquired through circular scans are shown in FIG. 7, wherein FIGS. 7A and 7B are the images of a finger at the levels of PIP and DIP joints respectively. Based on the optical contrast between various extra- and intra-articular tissues, soft tissue differentiation can be seen in these two images and match their corresponding histological photographs in FIGS. 7C and 7D respectively. These histological photographs of the finger were taken along the cross sections as closely matched as possible to those of the PAT images. In the histological photographs, AP: aponeurosis, PH: phalanx, SK: skin, SU: subcutaneous tissue, TE: tendon, and VP: volar plate. The small discrepancy between PAT findings and histological examinations is primarily due to the deformation of soft tissues during the histological procedure. Because the dominant absorption chromophores in the joints are hemoglobin at the applied wavelength, the contrast presented by PAT mainly reveals the blood concentrations in various articular tissues. It is also expected that the image quality including both the contrast and the spatial resolution of human joints in vivo is better, because the hemoglobin concentrations in living tissues are higher and, as a result, the optical contrast to be visualized is also stronger.

Turning now to another aspect of the present invention, the system and method according to the present invention may utilize an agent incorporating nanocolloids of any geometry including spheres, shells and rods and including, but not limited to, gold and its alloys, which may be combined with tumor necrosis factor antagonists including, but not limited to, etanercept, adalimumab, and infliximab for yielding a novel contrast agent, sensing mechanism, and/or treatment modality.

Tumor necrosis factor (TNF) has been identified as a cytokine produced by the immune system that plays a major role in suppression of tumor cell proliferation. Extensive research has revealed that TNF is also a major mediator of inflammation, viral replication, tumor metastasis, transplant rejection, inflammatory arthritis, and septic shock. Numerous recent investigations have pointed to a key role of the pro-inflammatory, pleotropic cytokine TNF-α in the processes of inflammatory diseases including rheumatoid arthritis, ankylosing spondylitis, and many other inflammatory responses. TNF-α over expression has been found in high levels in disease target tissues and in the circulation of patients with acute and chronic inflammatory diseases. For example, it has been shown that TNF-α is highly expressed in the rheumatoid arthritis synovium, including by lining layer cells, and synovial fluid, in lymphoid aggregates, by endothelial cells, and interestingly at the cartilage-pannus junction, which provides a molecular biomarker of inflammatory disease progression.

Because TNF has been implicated as one of the critical pathologic cytokines when overexpressed in associated inflammatory cascade, much work has been done to inhibit or antagonize TNF. The two strategies for inhibiting TNF that have been most extensively studied to date consist of monoclonal anti-TNF antibodies and soluble TNF receptors. Both constructs bind to circulating TNF-α, thus limiting its ability to engage cell membrane-bound TNF receptors and activate inflammatory pathways. It has been shown that members of the anti-TNF-α drug group, including both anti-TNF monoclonal antibodies and TNF receptors/binding proteins, have demonstrated efficacy in a number of serious and widespread medical conditions, including rheumatoid arthritis, juvenile rheumatoid arthritis, psoriatic arthritis, ankylosing spondylitis and Crohn's disease.

Three drugs, etanercept (fusion protein), adalimumab (D2E7) (human monoclonal antibody) and infliximab (chimeric monoclonal antibody) have been developed with the above strategies in mind and are currently FDA approved for various types of inflammatory diseases. In light of the major benefit these drugs have provided for hundreds of thousands of patients, many companies and research laboratories are searching for similar new anti-rheumatic drugs that may offer additional benefits such as improved long-term efficacy and reduced side effects.

Gold nanocolloids are particularly useful in optical absorption/scattering applications due to their strong optical responses and their biocompatible nature. Gold nanoparticles have exceptionally strong shape-dependent absorption in the visible and NIR spectral range, which is critical for optical and photoacoustic imaging. Gold nanoparticles have been shown to produce photoacoustic signals almost an order of magnitude higher than organic dyes in solutions of equal absorbance. Moreover, long-term imaging is not possible with organic dyes that photobleach and, in practice, limit imaging to a few colors. Gold nanorods, in particular, can possess very strong optical absorption in the NIR region. The high adsorption, in turn, results in an exceptionally high concentration of thermal energy produced by the conversion of photons to heat taking place during decay of plasmon oscillations. Consequently, the quick temperature rises around the gold nanoparticles on the order of 10 mK creates thermoelastic expansion that can be easily detected by ultrasound transducers. This effect is the source of high contrast and sensitivity of photoacoustic imaging using targeted gold nanostructures.

The strong optical scattering/absorption of gold nanoparticles at visible and NIR wavelengths is due to localized surface-plasmon resonance (LSPR). This is a classical effect in which the light's electromagnetic field drives the collective oscillations of the nanoparticle's free electrons into resonance. The characteristic wavelength of the plasmons is strongly determined by the geometry of the gold particles. Typical spherical nanoparticles display an absorption peak at 520-525 nm, which gradually shifts to the infrared region as the diameter of the particle increases. As such, the gold nanoparticles with a diameter of 100 nm have the plasmon peak at 600 nm. When gold nanocolloids have axial geometry and become nanorods, their optical behavior changes drastically and they exhibit two peaks. The smaller peak in the 500 nm range is due to the plasmon oscillations perpendicularly to the rod axis; while the strong NIR peak, which is tunable by varying the nanorod aspect ratio, originates from the longitudinal oscillations of plasmons along the main axis. Since NIR light transmits through tissue more efficiently than visible light, the additional plasmon resonance makes nanorods promising candidates for in vivo diagnostic and therapeutic applications. Gold nanorods are unique also because of their sharp resonance and their relatively small size, with their diameters approaching the molecular scale. Because the LSPR of small, dipole-limited particles is dominated by absorption, nanorods are best suited for applications that benefit from localized heating, such as PAT.

Gold nanocolloids have also been found to be very biocompatible and are approved by the FDA for systemic use. In large part, biocompatibility is attributed to the fact that gold is one of the inert noble metals. Also, the surface chemistry of gold is very well developed. One can attach a variety of biological targeted agents to gold nanoparticles using thiols as the organic coatings. Subsequent conjugation to proteins can be accomplished via standard methods. Surface modification techniques have been developed to bind biomolecules such as small peptides, proteins and DNA strands. Anti-TNF conjugated gold nanoparticles, including different shapes such as rods and spheres of varying sizes, could afford a new treatment for those with inflammatory diseases including arthritis.

Other nanoparticles with surface plasmon properties can be adapted to PAT according to the present invention provided that their optical features are located in visible and near infrared regions. They may include a variety of core-shell nanoparticles from inert metals, for instance gold-on-silver, or platinum-on-gold combinations. As well, the present invention also contemplates the use of some magnetic metals in core-shell structures coated with inert noble metals, such as iron, nickel, and cobalt. The magnetic properties of the nanoparticles could potentially help guide the nanocolloids to joint areas.

In accordance with an aspect of the present invention, gold nanocolloids can be bioconjugated with the anti-TNF-α drugs including etanercept, adalimumab and infliximab. This process entails synthesizing gold nanocolloids using standard procedures followed by colloid conjugation with anti-TNF-α drugs. Once conjugation has occurred, testing, with processes such as ELISA, can be completed to show conjugated drug is still active.

To conjugate nanocolloids and anti-TNF drugs, Au nanoparticles may be coated with stabilizers that bear the chemical groups including, but not limited to, —COOH., —NH₂, —COH, —SH. The stabilizer may originate from the initial synthesis or may be the result of surface exchange of chemical groups. Core-shell structures with silica-coated nanocolloids can be used as well. The attachment of thus made nanoparticles to the anti-TNF agents can precede via standard bioconjugation techniques. The present invention also contemplates that, in some instances, a flexible linker, such as PEG oligomers, may need to be inserted between the nanocolloid and the anti-TNF agent in order to achieve better functional parameters of the conjugated agent.

By combining nanocolloids with anti-TNF-α drugs for those patients using both of these types of formulations for treatments, a combination drug could be administered rather than individual applications, reducing the frequency of drug administration. Nanocolloids conjugated with anti-TNF-α drugs may prolong circulation time as compared to independent anti-TNF drugs or nanocolloids. This may reduce the amount and frequency of administration of nanocolloids conjugated with anti-TNF-α drugs as compared to either independently.

In light of new pharmacokinetics, new applications in inflammatory arthritis such as intraarticular injection of nanocolloids conjugated with anti-TNF-α drugs may be possible with equivalent or improved efficacy over existing methods. Nanocolloids conjugated with anti-TNF-α drugs may provide enhanced efficacy compared to use of anti-TNF drugs or nanocolloids independently. Furthermore, nanocolloids of varying sizes and shapes independently and in combination may have therapeutic advantages over existing formulations. These structures may have uses in autoimmune diseases such as inflammatory arthritis and other fields in medicine. Nanocolloids of varying shapes and sizes conjugated with anti-TNF-α drugs may have improved toxicity profiles over existing formulations of each independently. Nanocolloids conjugated with anti-TNF-α drugs provides a way for in vivo, non-ionizing, non-invasive, novel specific molecular imaging with spectroscopic or non-spectroscopic photoacoustic technology and multimodality technology as described above which may have imaging and sensing medical basic science, animal, clinical research and pharmaceutical industry uses.

It is understood that, according to the present invention, any antibody or substance specific for any molecule, cell, tissue, organ or non-organic substance which can be conjugated in some fashion to any nanocolloid could be used with or without any spectroscopic or non-spectroscopic photoacoustic system or any multimodality system incorporating or not incorporating photoacoustic technology sensing and/or imaging. Nanocolloids which could be used in the above systems include, but are not limited to, gold nanoparticles, gold nanoshells, gold nanorods, and gold nanocages with any dimension. Any other metallic nanocolloids with strong optical absorption, such as silver nanoparticles, or any other optical contrast agents may also be used. Thermal imaging and treatment modalities may be adapted to take advantage of nanocolloids combined with an antibody or substance specific for any molecule, cell, tissue, organ or non-organic substance which could be used in combination with or independently of any spectroscopic or non-spectroscopic photoacoustic system or any multimodality system as described above incorporating or not incorporating photoacoustic technology sensing and/or imaging. Other optical imaging modalities that can be employed for imaging and quantifying nanocolloids conjugated with anti-TNF-α drugs include, but are not limited to, confocal microscopy, two photon microscopy, fluorescent imaging, optical coherent tomography and diffuse optical tomography. Other enzyme, cytokine, cell surface or cell secondary messenger antagonists, and cyclic protein tyrosine kinase inhibitors, IL-6 antagonists, and pharmaceuticals including methotrexate, abetacept, rituximab, epratuzumab, belimumab, edratide, abetimus sodium, C5a inhibitors and FcgammaRIII inhibitors could be conjugated with nanocolloids and used together or separately in the fashion described above. Any of the above-described nanocolloid conjugates may also be used for local joint, tumor, or biological tissue injection, via intradermal, intravenous, subcutaneous, or intravenous administration.

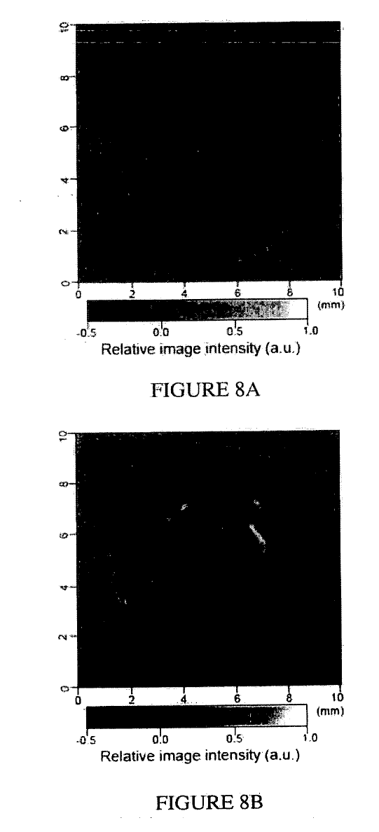

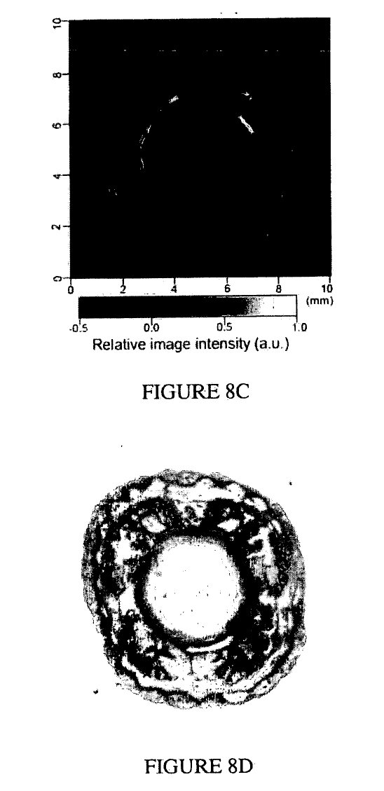

A study of PAT of joints aided by an Etanercept-conjugated gold nanoparticle contrast agent according to the present invention was conducted in rats. 2D photoacoustic cross-sectional imaging of rat joints in situ was conducted with laser light at 680 nm. The image in FIG. 8A was taken before the administrations of Etanercept conjugated gold nanorods, while the images in FIGS. 8B and 8C were taken after the first and the second administrations of the contrast agent. For each administration, the agent was injected intra-articularly through a needle via the direction indicated by the arrows in the images. For both the first and the second injections, 0.025 ml agent with a gold nanorod concentration of 10⁹ nanorods/ml (i.e. 10 picomolar) was introduced. The total number of gold nanorods introduced into the regional joint space for each injection was on the order of 10⁷. All the other experimental parameters for the images in FIGS. 8A-8C were the same, except that the specimen might be moved slightly during the administrations of the contrast agent.

With the optical contrast enhanced by the gold nanorods, the contour of the intra-articular connective tissue is presented much more clearly in the images in FIGS. 8B and 8C in comparison with the image in FIG. 8A which is based on the intrinsic tissue contrast. The hexagon shaped contour of the intra-articular connective tissue has been verified by the histological photograph of a similar cross section in a rat tail joint. The findings in FIGS. 8B and 8C are also consistent: with more gold nanorods injected and diffused in the intra-articular connective tissue more areas of tissue were “lightened”. This study has proven the capability of photoacoustic technology in tracing and quantifying gold nanorod based contrast agents in biological tissues. With PAT system according to the present invention, spatially distributed gold nanorod contrast agent with a concentration down to 10 picomolar in biological tissues can be imaged with very good signal-to-noise ratio and high spatial resolution.

In summary, the system and method according to the present invention contemplate the combination of gold nanocolloids of varying shapes and sizes with anti-TNF-α drugs for treatment use in inflammatory arthritis or other autoimmune diseases. Furthermore, the present invention includes the combination of nanocolloids of varying shapes and sizes, specifically gold, with antibodies or other substances specific for any molecule, cell, tissue, organ or non-organic substance, specifically anti-TNF-α drugs, for use with any spectroscopic or non-spectroscopic photoacoustic system or any multimodality system incorporating any type of spectroscopic or non spectroscopic photoacoustic sensing, imaging or treatment system.

The PAT system and method for joint imaging of the present invention overcome the limitations of other existing modalities and combine the high contrast of optical imaging with the high spatial resolution of ultrasound imaging. With this system and method, the contrast is based on the optical properties of biological tissues, but the resolution is not limited by optical diffusion or multiple photon scattering. In other words, PAT of inflammatory arthritis overcomes the resolution disadvantage of optical imaging and the contrast disadvantage of ultrasound imaging. In comparison with MRI, PAT is more sensitive to hemodynamic changes in inflamed joint tissues and is more cost-efficient. Moreover, in comparison with MRI and CT, PAT of joints is more likely to become a routinely used bedside tool for rheumatologists in the near future to enable objective diagnosis and sensitive monitoring of inflammatory joint diseases.

The PAT imaging system and method for joints according to the present invention include a combination of high optical contrast and high ultrasonic resolution, good imaging depth that enables the imaging of a finger joint as a whole organ, simultaneous functional imaging of tissue oxygenation state and blood volume, spectroscopic information presenting biological and biochemical changes, potential for imaging at molecular or genetic level by using bioactive contrast agents, low cost, non-ionizing, non-invasive, and minimal-dependence on operators, no speckle artifacts, and compatibility with ultrasonography systems to enable multi-modality imaging.

The system and method of the present invention include the ability to provide a high contrast, high resolution, three-dimensional map of a joint non-invasively without using ionizing sources. This system and method realize, for the first time, high quality imaging of a joint as a whole organ. The high ultrasonic resolution presented herein benefits the imaging of small joint structures in hands and feet, while the excellent optical contrast may greatly advance the diagnostic imaging and therapeutic monitoring of inflammatory joint diseases, such as rheumatoid arthritis. Besides morphological imaging of joint tissue structures, the system and method of the present invention also enable functional spectroscopic analysis in a point-by-point manner in a joint. Moreover, by employing optical contrast agents conjugated with bioactive materials, such as protein, antibodies, and drugs, the system and method can be used to study inflammatory arthritis at the cellular or molecular level.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for photoacoustic tomography of a sample, the system comprising:
a light source configured to deliver light to the sample;
an ultrasonic transducer disposed adjacent to the sample for receiving photoacoustic signals generated due to optical absorption of the light by the sample;
a motor operably connected to at least one of the sample and the ultrasonic transducer for varying a position of the sample and the transducer with respect to one another along a scanning path; and
a control system in communication with the light source, the ultrasonic transducer, and the motor for reconstructing photoacoustic images of the sample from the received photoacoustic signals.

2. The system according to claim 1, wherein the light source includes a pulsed light source.

3. The system according to claim 1, wherein the control system receives a firing trigger from the light source.

4. The system according to claim 1, wherein the control system controls tuning a wavelength of the light source.

5. The system according to claim 1, wherein the ultrasonic transducer includes an annular array.

6. The system according to claim 1, wherein the ultrasonic transducer includes an arcuate array.

7. The system according to claim 1, wherein the ultrasonic transducer includes a linear array.

8. The system according to claim 1, wherein the scanning path is circular.

9. The system according to claim 1, wherein the scanning path is arcuate.

10. The system according to claim 1, wherein the scanning path is linear.

11. The system according to claim 1, wherein the sample includes a mammalian joint.

12. The system according to claim 1, further comprising nanocolloids provided within the sample.

13. The system according to claim 12, wherein the nanocolloids include gold.

14. The system according to claim 12, wherein the nanocolloids include magnetic metals.

15. The system according to claim 12, wherein the nanocolloids are conjugated to anti-tumor necrosis factor drugs.

16. A method for photoacoustic tomography of a sample, the method comprising;
delivering light to the sample from a light source;
receiving photoacoustic signals generated due to optical absorption of the light by the sample with an ultrasonic transducer;
varying a position of at least one of the sample and the ultrasonic transducer with respect to one another along a scanning path; and
reconstructing photoacoustic images from the received photoacoustic signals.

17. The method according to claim 16, wherein delivering light includes irradiating the sample from one side.

18. The method according to claim 16, wherein delivering light includes irradiating the sample from all directions.

19. The method according to claim 16, wherein varying the position of at least one of the sample and the ultrasonic transducer generates a cylindrical scan.

20. The method according to claim 16, wherein varying the position of at least one of the sample and the ultrasonic transducer generates a spherical scan.

21. The method according to claim 16, wherein the scanning path is circular.

22. The method according to claim 16, wherein the scanning path is arcuate.

23. The method according to claim 16, wherein the scanning path is linear.

24. The method according to claim 16, further comprising receiving a firing trigger from the light source.

25. The method according to claim 16, further comprising tuning a wavelength of the light source.

26. The method according to claim 16, wherein the sample includes a mammalian joint.

27. The method according to claim 16, further comprising providing nanocolloids within the sample.

28. The method according to claim 27, wherein the nanocolloids include gold.

29. The method according to claim 27, wherein the nanocolloids include magnetic metals.

30. The method according to claim 27, further comprising conjugating the nanocolloids to anti-tumor necrosis factor drugs.

31. A system for photoacoustic tomography of a mammalian joint, the system comprising:
a light source configured to deliver light pulses to the joint;
an ultrasonic transducer disposed adjacent to the joint for receiving photoacoustic signals generated due to optical absorption of the light pulses from the light source by the joint, the ultrasonic transducer including an annular-shaped array;
optical fibers in communication with the light source, the optical fibers including output ends arranged along a circle adjacent the transducer array so that light in each fiber is delivered toward the center of the circle; and
a control system in communication with the light source and the ultrasonic transducer for reconstructing photoacoustic images from the received photoacoustic signals.
